(19) United States
(12) Patent Application Publication
(10) Pub. No.: US 2014/0331145 A1
(43) Pub. Date: Nov. 6, 2014

(54) ENHANCING A REMOTE DESKTOP WITH META-INFORMATION

(71) Applicant: NVIDIA CORPORATION, Santa Clara, CA (US)

(72) Inventor: Stefan SCHOENEFELD, Aachen (DE)

(73) Assignee: NVIDIA CORPORATION, Santa Clara, CA (US)

(21) Appl. No.: 13/887,872

(22) Filed: May 6, 2013

(51) Int. Cl. H04L 12/24

(52) U.S. Cl. CPC H04L 41/22
USPC 715/740

(57) ABSTRACT

One embodiment of the present invention sets forth a technique for interacting with a graphical user interface. The technique involves generating a first image of a graphical user interface having a plurality of input fields and determining first input field information associated with a first input field included in the plurality of input fields. The first input field information includes a first input field type and a first input field location. The technique further involves transmitting the first image and the first input field information to a first device and receiving a first input event associated with the first input field from the first device. Finally, the technique involves generating a second image of the graphical user interface based on the first input event and transmitting the second image to the first device.

### BACKGROUND OF THE INVENTION

1. Field of the Invention

The present invention generally relates to computer network architecture and, more specifically, to enhancing a remote desktop with meta-information.

2. Description of the Related Art

Remote desktop software enables an end-user to view and interact with an application executing on a remote computing device. For example, an end-user may operate remote desktop software on a local computer to establish a connection with a remote computer via a local or wide area network. Once a connection is established, the remote computer may transmit a graphical user interface (GUI) to the local computer, enabling the end-user to access files and/or execute applications stored on the remote computer.

In operation, conventional remote desktop software allows an end-user on a local computer to interact with applications executing on the remote computer by operating a mouse and keyboard attached to the local computer. Mouse and keyboard events inputted by the end-user are then transmitted by the local computer through the network and executed by the remote computer. Thus, using a mouse and keyboard, an end-user is able to access and use various types of software applications stored on the remote computer without difficulty.

Advances in display and input sensing technologies have led to new types of computing devices, many of which no longer use conventional mouse devices and keyboards. Accordingly, when executing remote desktop software on these computing devices, an end-user may have difficulty interacting with applications that are designed for use with a mouse and keyboard. For example, executing a particular command associated with an application may require a series of mouse clicks, mouse movements, and/or keyboard key strokes. Such complex input events may be difficult to replicate on various types of computing devices, such as those which use touchscreen and/or motion-sensing technologies.

Accordingly, there is a need in the art for a way to allow end-users to more effectively interact with remote software applications via machines configured with non-conventional display and/or input technologies.

### SUMMARY OF THE INVENTION

One embodiment of the present invention sets forth a method for interacting with a graphical user interface. The method involves generating a first image of a graphical user interface having a plurality of input fields and determining first input field information associated with a first input field included in the plurality of input fields. The first input field information includes a first input field type and a first input field location. The method further involves transmitting the first image and the first input field information to a first device and receiving a first input event associated with the first input field from the first device. Finally, the method involves generating a second image of the graphical user interface based on the first input event and transmitting the second image to the first device.

Further embodiments provide a non-transitory computer-readable medium and a computing device configured to carry out the method set forth above.

Advantageously, the disclosed technique enables a user to interact with a software application executing on a remote computer by converting user input (e.g., touchscreen input) into one or more input events based on the type of input field the user is selecting and transmitting the input events to the remote computer.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates a system configured to implement one or more aspects of the present invention;

FIG. 1B sets forth a more detailed illustration of a client device or server device of FIG. 1A, according to one embodiment of the invention;

FIG. 2 illustrates the parallel processing subsystem of FIG. 1B, according to one embodiment of the present invention;

FIG. 3 illustrates a graphical user interface generated by the server device of FIG. 1A, according to one embodiment of the invention;

FIG. 4A is a conceptual illustration of the flow of input field information and image data between a client device and the server device, according to one embodiment of the invention;

FIG. 4B illustrates various types of input field information generated by input field engine and/or stored in an input field database, according to one embodiment of the invention;

FIG. 5 is a flow diagram of method steps for interacting with a graphical user interface via a server device, according to one embodiment of the present invention; and

FIG. 6 is a flow diagram of method steps for interacting with a graphical user interface via a client device, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

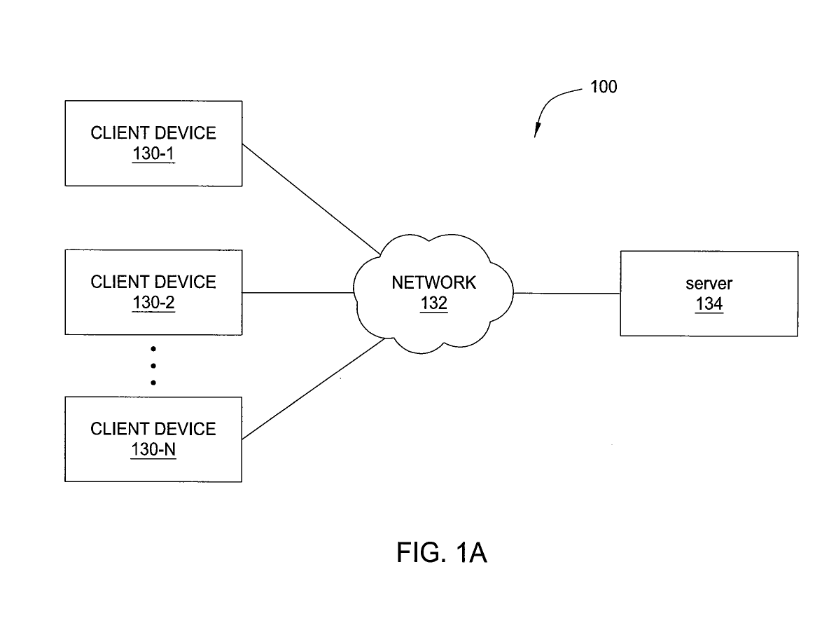

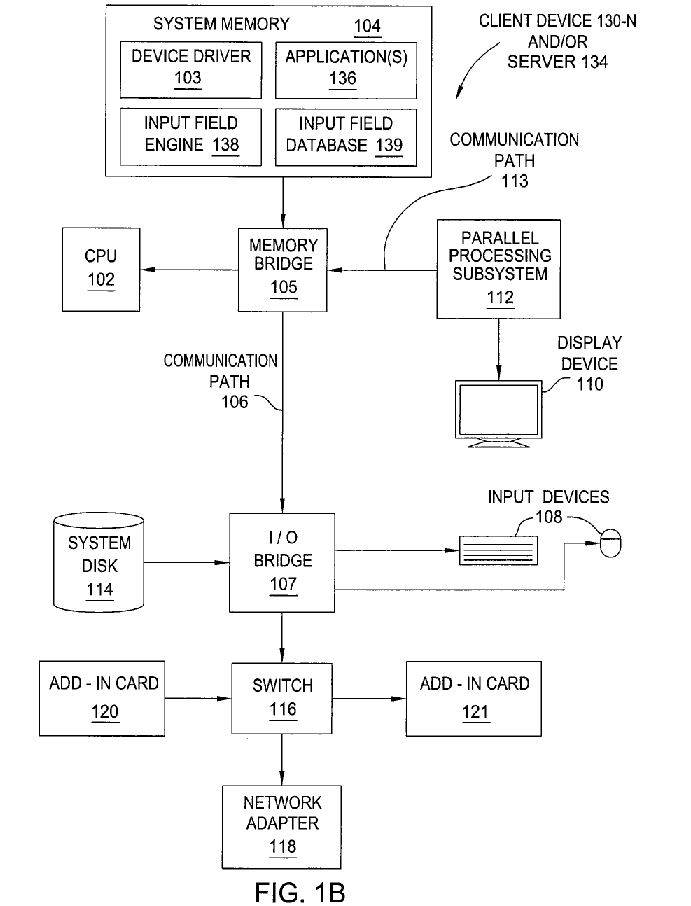

FIG. 1A illustrates a system 100 configured to implement one or more aspects of the present invention. As shown, the system 100 includes, without limitation, one or more client devices 130 configured to transmit data to and receive data from a server device 134 through a network 132. More specifically, as discussed in greater detail below in conjunction with FIG. 1B, a server device 134 executes at least one software application and an input field engine. The input field engine determines input field information for one or more input fields included in a graphical user interface (GUI). For example, the input field engine may determine that the GUI includes a textual input field type. In addition to determining the type(s) of input field(s), the input field engine may further determine input field information, such as the location, size, input parameters, etc. associated with the input field(s). The input field engine then transmits the input field information and an image of the GUI to a client device 130.

The client device 130 is configured to receive and display the GUI image to a user. The client device 130 is further configured to generate one or more input fields based on the input field information. For example, the client device 130 may generate a textual input field and, based on the input field information, associate the textual input field with one or more regions of the GUI image displayed to the user. The client device 130 then receives user input associated with one or more input fields and processes the user input. In one example, if user input is received for a region of the GUI image associated with the textual input field, the client device 130 may process the user input to generate an input event to select the input field and enable the user to input text. In another example, if user input is received for a region of the GUI image associated with a three-dimensional (3D) viewport input field, the client device 130 may process the user input to generate an input event which pans, zooms, rotates, etc. to enable the user to navigate the 3D viewport. Once the user input has been processed, the input event is transmitted back to the input field engine in the server device 134.

Upon receiving an input event, the server device 134 executes the input event with the software application. The input field engine then generates an updated GUI image and/or updated input field information and transmits the updated GUI image and/or updated input field information to the client device 130. For example, the input field engine may execute the input event to edit text or rotate a map in the 3D viewport. An updated GUI image with the edited text or rotated map is then transmitted to the client device 130.

The client device 130 may be any type of electronic device that enables a user to connect to and communicate with (e.g., via the Internet, a local area network (LAN), an ad hoc network, etc.) the server device 134. Exemplary electronic devices include, without limitation, desktop computing devices, portable or hand-held computing devices, laptops, tablets, smartphones, mobile phones, personal digital assistants (PDAs), etc. In one embodiment, the client device 130 is touchscreen device which receives user input (e.g., via a stylus, one or more fingers, hand gestures, eye motion, voice commands, etc.) and, based on input field information, processes the user input to generate one or more input events, which are transmitted to the server device 134.

FIG. 1B sets forth a more detailed illustration of a client device 130 or server device 134 of FIG. 1A, according to one embodiment of the invention. The client device 130 and/or server device 134 includes a central processing unit (CPU) 102 and a system memory 104 communicating via an interconnection path that may include a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via communication path 106 and memory bridge 105. A parallel processing subsystem 112 is coupled to memory bridge 105 via a bus or second communication path 113 (e.g., a Peripheral Component Interconnect (PCI) Express, Accelerated Graphics Port, or HyperTransport link); in one embodiment parallel processing subsystem 112 is a graphics subsystem that delivers pixels to a display device 110 that may be any conventional cathode ray tube, liquid crystal display, light-emitting diode display, or the like. A system disk 114 is also connected to I/O bridge 107 and may be configured to store content and applications and data for use by CPU 102 and parallel processing subsystem 112. System disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices.

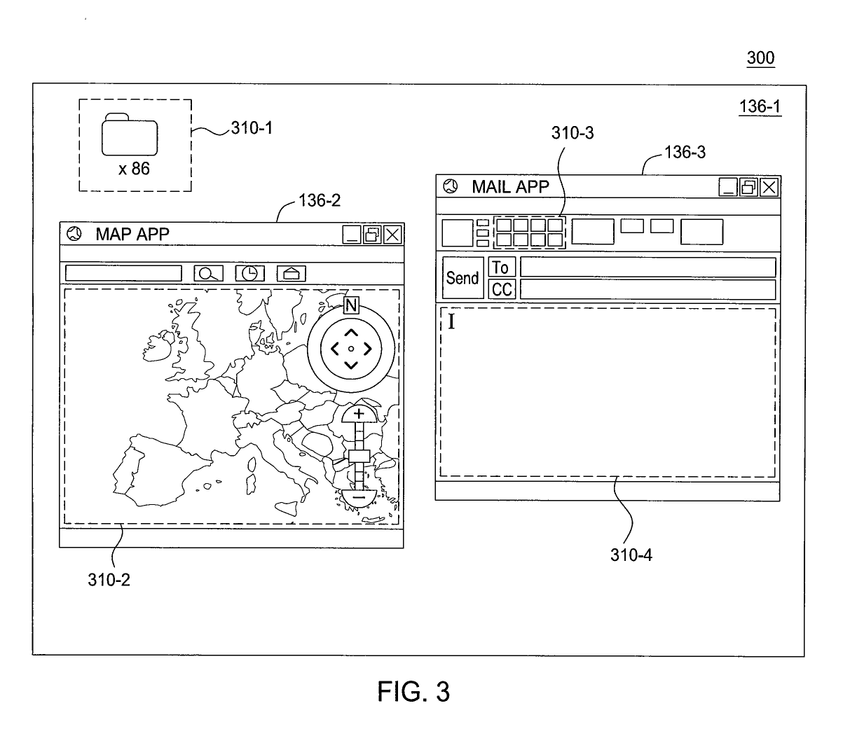

The system memory 104 may store one or more software applications 136 to be executed by the client device 130 and/or server device 134. The system memory 104 may further store an input field engine 138 and an input field database 139. In one embodiment, the system memory 104 of the server device 134 may store a software application 136, and GUI images and input field information associated with the software application 136 may be generated and transmitted to a client device 130 by the input field engine 138. Additionally, input field information generated by the input field engine 138 may be stored in and/or based on one or more entries of the input field database 139, as described in further detail with respect to FIG. 3.

A switch 116 provides connections between I/O bridge 107 and other components such as a network adapter 118 and various add-in cards 120 and 121. Other components (not explicitly shown), including universal serial bus (USB) or other port connections, compact disc (CD) drives, digital versatile disc (DVD) drives, film recording devices, and the like, may also be connected to I/O bridge 107. The various communication paths shown in FIG. 1, including the specifically named communication paths 106 and 113 may be implemented using any suitable protocols, such as PCI Express, AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements in a single subsystem, such as joining the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip instead of existing as one or more discrete devices. Large embodiments may include two or more CPUs 102 and two or more parallel processing subsystems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

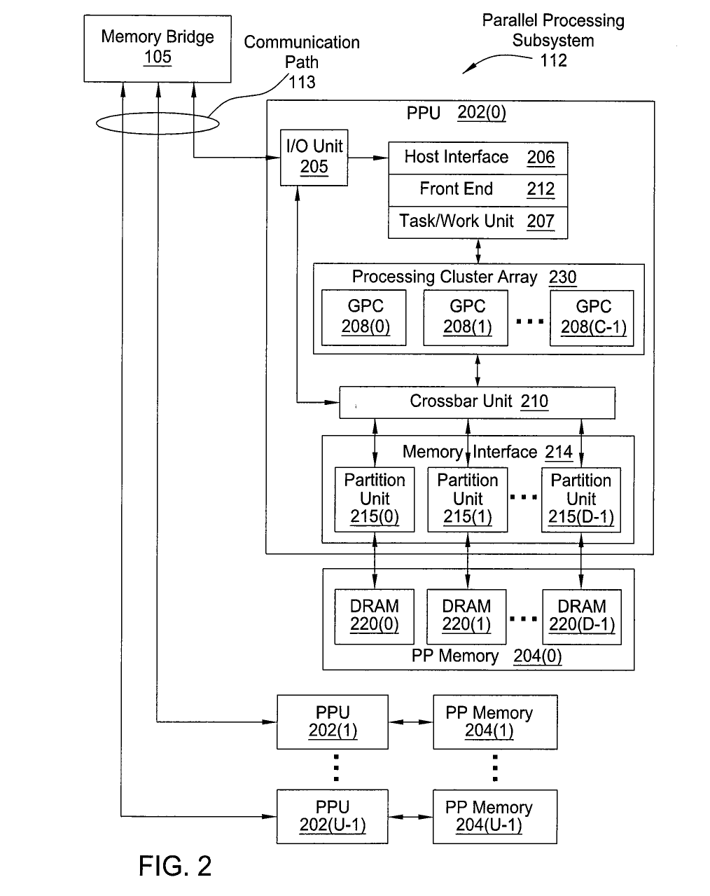

FIG. 2 illustrates the parallel processing subsystem 112 of FIG. 1B, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), or memory devices, or in any other technically feasible fashion.

Referring again to FIG. 1B as well as FIG. 2, in some embodiments, some or all of PPUs 202 in parallel processing subsystem 112 are graphics processors with rendering pipelines that can be configured to perform various operations related to generating pixel data (e.g., GUI images) from graphics data supplied by CPU 102 and/or system memory 104 via memory bridge 105 and the second communication path 113, interacting with local parallel processing memory 204 (which can be used as graphics memory including, e.g., a conventional frame buffer) to store and update pixel data, delivering pixel data to the display device 110, a client device 130, and the like. In some embodiments, parallel processing subsystem 112 may include one or more PPUs 202 that operate as graphics processors and one or more other PPUs 202 that are used for general-purpose computations. The PPUs may be identical or different, and each PPU may have a dedicated parallel processing memory device(s) or no dedicated parallel processing memory device(s). One or more PPUs 202 in parallel processing subsystem 112 may output data to the display device 110 and/or client device 130, or each PPU 202 in parallel processing subsystem 112 may output data to one or more display devices 110 and/or client devices 130.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a data structure (not explicitly shown in either FIG. 1 or FIG. 2) that may be located in system memory 104, parallel processing memory 204, or another storage location accessible to both CPU 102 and PPU 202. A pointer to each data structure is written to a pushbuffer to initiate processing of the stream of commands in the data structure. The PPU 202 reads command streams from one or more pushbuffers and then executes commands asynchronously relative to the operation of CPU 102. Execution priorities may be specified for each pushbuffer by an application program via the device driver 103 to control scheduling of the different pushbuffers.

Referring back now to FIG. 2 as well as FIG. 1B, each PPU 202 includes an I/O (input/output) unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/O bridge 107. In still other embodiments, some or all elements of PPU 202 may be integrated on a single chip with CPU 102.

In one embodiment, communication path 113 is a PCI Express link, in which dedicated lanes are allocated to each PPU 202, as is known in the art. Other communication paths may also be used. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each pushbuffer and outputs the command stream stored in the pushbuffer to a front end 212.

Each PPU 202 advantageously implements a highly parallel processing architecture. As shown in detail, PPU 202(0) includes a processing cluster array 230 that includes a number C of general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. For example, a GPC 208 may be allocated for processing an input field and/or GUI image associated with a software application 136 in order to generate input field information. The allocation of GPCs 208 may vary dependent on the workload arising for each type of program or computation.

GPCs 208 receive processing tasks to be executed from a work distribution unit within a task/work unit 207. The work distribution unit receives pointers to processing tasks that are encoded as task metadata (TMD) and stored in memory. The pointers to TMDs are included in the command stream that is stored as a pushbuffer and received by the front end unit 212 from the host interface 206. Processing tasks that may be encoded as TMDs include indices of data to be processed, as well as state parameters and commands defining how the data is to be processed (e.g., what program is to be executed). The task/work unit 207 receives tasks from the front end 212 and ensures that GPCs 208 are configured to a valid state before the processing specified by each one of the TMDs is initiated. A priority may be specified for each TMD that is used to schedule execution of the processing task. Processing tasks can also be received from the processing cluster array 230. Optionally, the TMD can include a parameter that controls whether the TMD is added to the head or the tail for a list of processing tasks (or list of pointers to the processing tasks), thereby providing another level of control over priority.

Memory interface 214 includes a number D of partition units 215 that are each directly coupled to a portion of parallel processing memory 204, where D 1. As shown, the number of partition units 215 generally equals the number of dynamic random access memory (DRAM) 220. In other embodiments, the number of partition units 215 may not equal the number of memory devices. Persons of ordinary skill in the art will appreciate that DRAM 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Any one of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the embodiment shown in FIG. 2, crossbar unit 210 is directly connected with I/O unit 205. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), image analysis (e.g., input field processing and analysis), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory exclusively or almost exclusively. In UMA embodiments, a PPU 202 may be integrated into a bridge chip or processor chip or provided as a discrete chip with a high-speed link (e.g., PCI Express) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

FIG. 3 illustrates a graphical user interface (GUI) 300 generated by the server device 134 of FIG. 1A, according to one embodiment of the invention. As shown, the GUI 300 includes an operating system software application 136-1, a mapping software application 136-2, and a messaging software application 136-3. In one embodiment, the software applications 136 are executed on the server device 134 and images of GUI 300 are transmitted to the client device 130 over a network 132. Although various types of software applications 136 and input fields 310 are described in conjunction with the GUI 300 illustrated in FIG. 3, persons skilled in the art will understand that other types of software applications 136 and input fields 310 are within the scope of the invention.

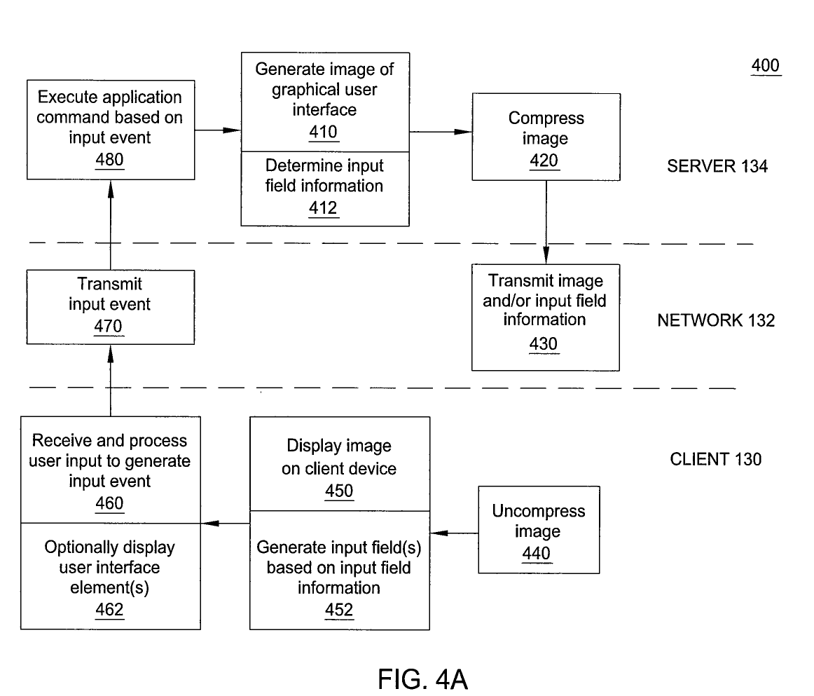

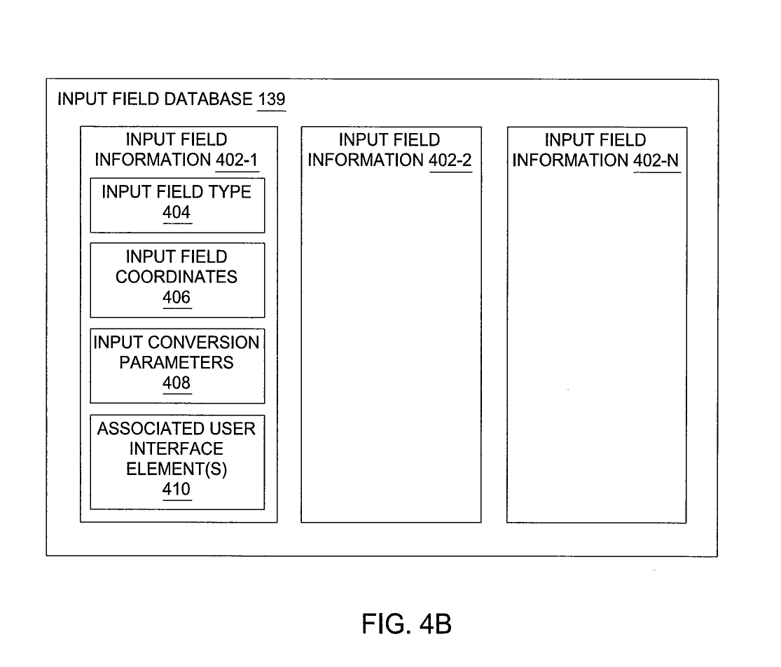

The software applications 136 executing on the server device 134 may include one or more types of input fields 310 with which a user of a client device 130 may interact. For example, the operating system software application 136-1 may include a file/folder input field 310-1 with which a user may interact to select, open, move, rename, modify, or delete a file or folder. In addition, the mapping software application 136-2 may include a 2D or 3D viewport input field 310-2 with which a user may interact to pan, zoom, rotate, etc. a map. Further, the messaging software application 136-3 may include a small element input field 310-3, with which a user may interact to select a user interface elements (e.g., an icon or button) having a small size relative to an input object (e.g., a finger used with a touchscreen device), and a textual input field 310-4, into which a user may input text. In one embodiment, the software applications 136 executing on the server device 134 are designed to be operated with conventional input devices, such as a mouse and/or keyboard. Consequently, user input received by the client device 130 may be converted into input events recognized by the software applications 136. Various techniques for interacting with the GUI 300 using a client device 130 are described below in further detail with respect to FIGS. 4A and 4B.

FIG. 4A is a conceptual illustration of the flow of input field information and image data between a client device 130 and the server device 134, according to one embodiment of the invention. As shown, at step 410, the server device 134 generates an image of a graphical user interface (e.g., GUI 300) associated with one or more software applications 136. At step 412, an input field engine 138 executing on the server device 134 determines input field information 402 associated with one or more of the input fields 310 included in the GUI 300.

As shown in FIG. 4B, which illustrates various types of input field information 402 stored in an input field database 139, according to one embodiment of the invention, the input field information 402 determined by the input field engine 138 may include an input field type 404, input field coordinates 406, input conversion parameters 408, and/or one or more associated user interface elements 410. For example, with reference to the GUI 300 shown in FIG. 3, the input field engine 138 may determine that input field 310-1 has a ‘file/folder’ input field type 404. The input field engine 138 also may determine the coordinates 406 of input field 310-1 (e.g., the maximum/minimum x and y pixel coordinates of the boundaries of the input field 310) and the input conversion parameters 408 associated with the input field 310-1. Further, the input field engine 138 (and/or the client device 130) may determine whether one or more user interface elements are to be displayed when the user interacts with the input field 310-1; this information may be stored as associated user interface element(s) information 410 in the input field information 402.

The input conversion parameters 408 associated with an input field 310 may specify how user input received by the client device 130 (e.g., a touchscreen device) is to be converted into an input event (e.g., a conventional mouse/keyboard input event) that a software application 136 executing on the server device 134 is capable of recognizing and executing. For example, if the client device 130 includes a touchscreen input device, input conversion parameters 408 associated with the file/folder input field type 404 may specify that a first type of user input (e.g., a finger touch and lift) on the file/folder input field 310-1 is to be converted into a first input event (e.g., a double-click mouse event) which selects and opens the file or folder. Further, the input conversion parameters 408 may specify that a second type of user input (e.g., a finger touch and hold) and a third type of user input (e.g., a finger touch, hold, and drag) on the file/folder input field 310-1 are to be converted into a second input event (e.g., a right-click mouse event) which displays a file/folder context menu and a third input event (e.g., a click, hold, and drag mouse event) which grabs and drags the file/folder across the GUI 300, respectively.

In another example, the input field engine 138 may determine that input field 310-2 has a ‘viewport’ input field type 404. The input field engine 138 may then determine the coordinates of the input field 310-2 and the input conversion parameters 408 associated with the input field 310-2. For example, if the client device 130 includes a touchscreen input device, input conversion parameters 408 associated with the viewport input field type 404 may specify that a first type of user input (e.g., a finger touch and lift) on the viewport input field 310-2 is to be converted into a first input event (e.g., a single-click mouse event) which selects an object (e.g., a location on the map) in the viewport. Further, the input conversion parameters 408 may specify that a second type of user input (e.g., a double finger touch and lift) and a third type of user input (e.g., a finger touch, hold, and drag) on the viewport input field 310-2 are to be converted into a second input event (e.g., a scroll wheel up mouse event) which zooms in on the contents of the viewport input field 310-2 and a third input event (e.g., a click, hold, and drag mouse event) which pans the contents of the viewport input field 310-2, respectively. Although each of the examples provided above convert user input into mouse-related input events, user input may be converted into any type of input event (e.g., a keyboard input event) recognized by a software application 136 executing on the server device 134.

Further, the input field information 402 may indicate whether one or more user interface elements are to be displayed when the user interacts with the input field 310-1. This information may be stored in an associated user interface element(s) 410 entry in an input information field 402. In one embodiment, with reference to the messaging software application 136-3 shown in FIG. 3, when a user interacts with the textual input field 310-4, the client device 130 and/or server 134 may display one or more user interface elements. For example, when a user interacts with the textual input field 310-4, the client device 130 may display a virtual keyboard (e.g., a virtual touchscreen keyboard) to enable the user to input text into the textual input field 310-4. In another example, when a user interacts with the small element input field 310-3, the client device 130 may display a zoom window proximate to the small element input field 310-3 to enable the user to more easily select a small user interface element (e.g., when using an input object larger than the interface element to operate a touchscreen device).

Referring back now to FIG. 4A, prior to transmitting the image of the GUI 300 and the input field information 402 over the network 132 at step 430, the server device 134 may compress the image at step 420. Once the client device 130 receives the image of the GUI 300, the image may be uncompressed at step 440 and displayed to the user at step 450. The client device 130 then generates one or more input fields 310 based on the input field information 402 received from the server device 134. Next, the user interacts with the GUI 300, and, at step 460, the client device 130 receives and processes the user input to generate an input event. As described above, the input event may be generated based on input conversion parameters 408 stored in the input field information 402. Optionally, at step 462, the client device 130 may display one or more user interface elements (e.g., virtual keyboard, zoom window, context menu, etc.) to enable the user to interact with the input field(s) 310.

At step 470, the input event(s) are transmitted over the network 132 to the server device 134, which receives the input event(s) and executes an application command based on the input event(s) at step 480. The process of generating an updated image of the GUI 300 and determining input field information 402 may then be repeated beginning at step 410.

In addition to the techniques described above, input field information 402 may be generated by the client device 130 and/or server device 134 by analyzing the GUI 300. For example, the input field engine 138 may perform an analysis of the GUI 300 and compare user interface elements with known user interface elements to determine that one or more types of input fields 310 are present in the GUI 300. GUI 300 analysis may be performed, for example, by the CPU 102 and/or by a GPC 208 in the parallel processing subsystem 112. The input field engine 138 may then assign input field information 402 to the input field(s) 310, for example, based on one or more entries stored in the input field database 139. In one example, the input field engine 138 may analyze the GUI 300 to determine that a textual input field 310 is present (e.g., by identifying a cursor, text, formatting icons, etc.). The input field engine 138 may then retrieve input field information 402 (e.g., input conversion parameters 408, associated user interface elements 410, etc.) associated with a textual input field 310 from the input field database 139 and assign the input field information 402 to the textual input field 310.

In yet another technique for generating and/or assigning input fields 310 and input field information 402, a user of the client device 130 and/or server 134 may designate one or more regions of the GUI 300 as including input field type(s) 404. The user may further specify input conversion parameters 408 and/or associated user interface element(s) 410 for the input field(s) 310. These user-assigned attributes may then be stored as input field information 402 and/or transmitted to the server device 134.

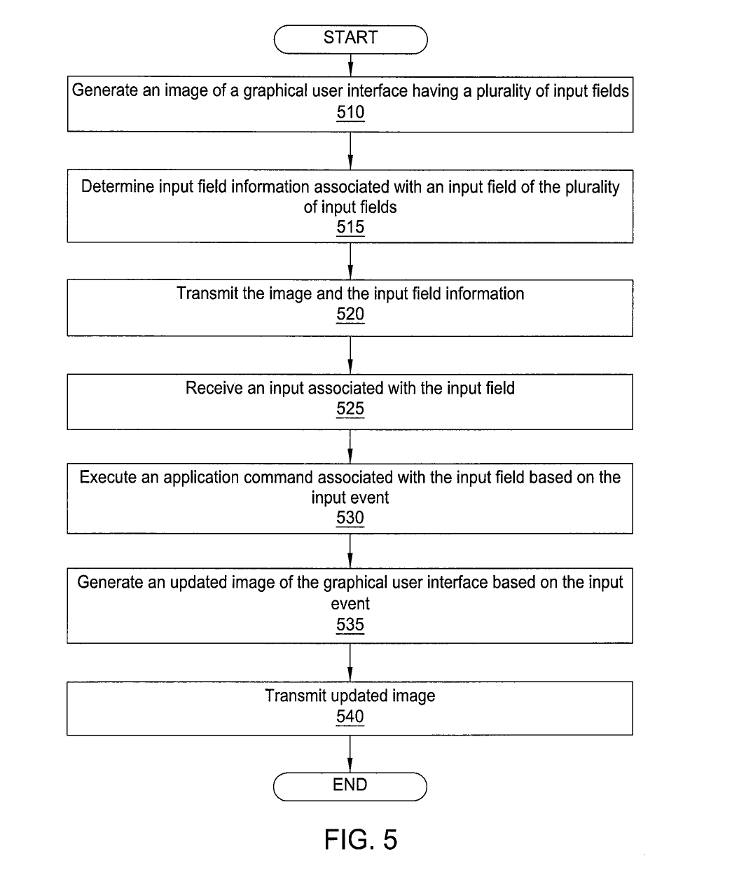

FIG. 5 is a flow diagram of method steps for interacting with a graphical user interface via a server device, according to one embodiment of the present invention. Although the method steps are described in conjunction with the systems of FIGS. 1A-4B, persons skilled in the art will understand that any system configured to perform the method steps, in any order, falls within the scope of the present invention.

As shown, a method 500 begins at step 510, where an image of the GUI 300 is generated by the server device 134 (e.g., by the input field engine 138). The GUI 300 may include one or more input fields 310. At step 515, input field information 402 is determined for the input field(s) 310. At step 520, the image of the GUI 300 and the input field information 402 is transmitted over the network 132 to the client device 130.

Next, at step 525, the server device 134 receives one or more input events associated with the one or more input fields 310. The server device 134 then executes an application command (e.g., with a software application 136) associated with the one or more input fields 310 based on the input event(s) at step 530. At step 535, the server device 134 generates an updated GUI 300 image based on the input event(s) and transmits the updated GUI 300 image to the client device 130 at step 540.

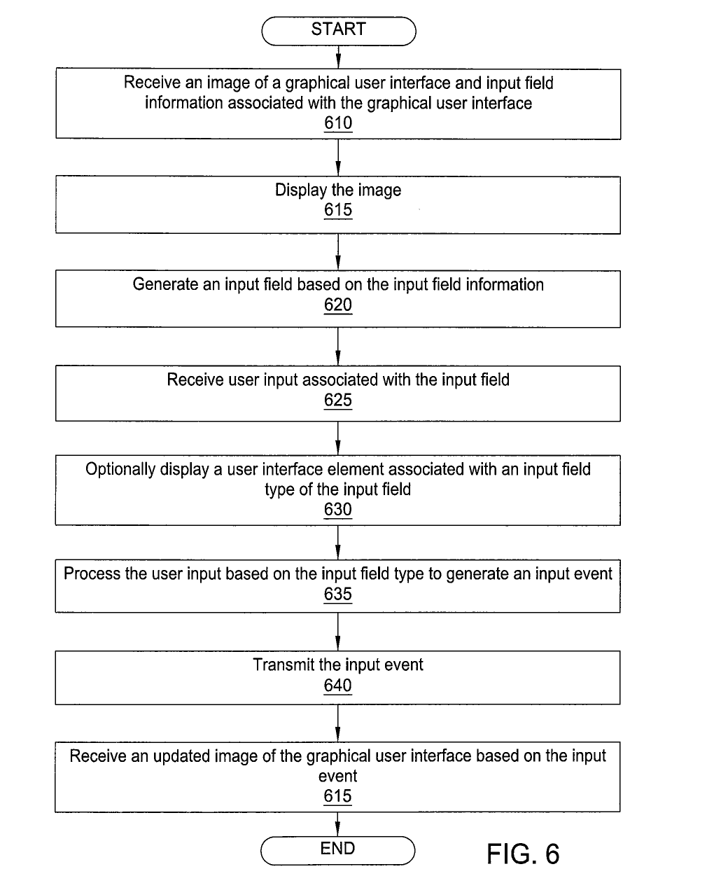

FIG. 6 is a flow diagram of method steps for interacting with a graphical user interface via a client device, according to one embodiment of the present invention. Although the method steps are described in conjunction with the systems of FIGS. 1A-4B, persons skilled in the art will understand that any system configured to perform the method steps, in any order, falls within the scope of the present invention.

As shown, a method 600 begins at step 610, where an image of the GUI 300 and input field information 402 associated with the GUI 300 is received by the client device 130. At step 615, the client device 130 displays the image. At step 620, the client device 130 generates one or more input fields 310 based on the input field information 402.

Next, at step 625, the client device 130 receives user input associated with one or more input fields 310. Optionally, the client device 130 may display one or more user interface elements associated with the input field(s) 310 at step 630. The client device 130 then processes the user input to generate an input event at step 635. At step 640, the input event is transmitted over the network 132 to the server device 134. An updated GUI 300 image (e.g., generated based on the input event) is then received from the server device 134 at step 645.

In sum, an input field engine executing on a remote computing device, such as a server machine, determines input field information, including a type and location, for each input field included in a graphical user interface (GUI). The input field information and an image of the GUI are transmitted to a client device, which displays the GUI image and generates one or more input fields based on the input field information. The client device then receives user input associated with the input field and processes the user input to generate an input event, which is transmitted back to the input field engine. In response, the input field engine executes the input event and transmits an updated GUI image to the client device.

One advantage of the disclosed technique is that users of machines that are configured with non-conventional input devices (e.g., machines with touchscreen technology) are able to more effectively control remote software applications designed for machines having conventional input device (e.g., machines that have a mouse and/or keyboard).

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., hard-disk drive or any type of solid-state semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

What is claimed is:

1. A computer-implemented method for interacting with a graphical user interface, the method comprising:
generating a first image of a graphical user interface having a plurality of input fields;
determining first input field information associated with a first input field included in the plurality of input fields, wherein the first input field information comprises a first input field type and a first input field location;
transmitting the first image and the first input field information to a first device;
receiving a first input event associated with the first input field from the first device;
generating a second image of the graphical user interface based on the first input event; and
transmitting the second image to the first device.

2. The method of claim 1, further comprising:
determining second input field information associated with a second input field included in the plurality of input fields, wherein the second input field information comprises a second input field type and a second input field location;
transmitting the second input field information with the first image and the first input field information to the first device;
receiving a second input event associated with the second input field from the first device;
generating a third image of the graphical user interface based on the second input event; and
transmitting the third image to the first device.

3. The method of claim 1, wherein the first input field location comprises coordinates associated with a location of the first input field.

4. The method of claim 1, further comprising executing an application command associated with the first input field based on the first input event.

5. The method of claim 1, wherein determining the first input field information comprises:
comparing the plurality of input fields to a plurality of known input field types; and
determining that the first input field matches an input field type included in the plurality of known input field types.

6. The method of claim 1, wherein determining the first input field information comprises:
analyzing the first image to identify the first input field;
comparing a portion of the first image associated with the first input field to a plurality of known input field types; and
determining that the portion of the first image associated with the first input field matches an input field type included in the plurality of known input field types.

7. The method of claim 1, wherein the first device comprises a touchscreen device.

8. The method of claim 1, further comprising:
receiving the first image and the first input field information;
displaying the first image to a user of the first device;
generating the first input field based on the first input field information;
receiving from the user first user input that is associated with the first input field;
transmitting, to a second device, the first input event based on the first user input; and
receiving, from the second device, the second image of the graphical user interface based on the first input event with the first device.

9. The method of claim 8, further comprising:
reading first input conversion information associated with the first input field type; and
converting the first user input into the first input event based on the first input conversion information, wherein the first user input comprises touchscreen input, and the first input event comprises at least one of a pointing device event and a keyboard event.

10. The method of claim 8, further comprising displaying to the user a user interface element associated with the first input field type in response to receiving the first user input.

11. A non-transitory computer-readable storage medium including instructions that, when executed by a processing unit, cause the processing unit to interact with a graphical user interface, by performing the steps of:
generating a first image of a graphical user interface having a plurality of input fields;
determining first input field information associated with a first input field included in the plurality of input fields, wherein the first input field information comprises a first input field type and a first input field location;
transmitting the first image and the first input field information to a first device;
receiving a first input event associated with the first input field from the first device;
generating a second image of the graphical user interface based on the first input event; and
transmitting the second image to the first device.

12. The non-transitory computer-readable storage medium of claim 11, further comprising the steps of:
determining second input field information associated with a second input field included in the plurality of input fields, wherein the second input field information comprises a second input field type and a second input field location;
transmitting the second input field information with the first image and the first input field information to the first device;
receiving a second input event associated with the second input field from the first device;
generating a third image of the graphical user interface based on the second input event; and
transmitting the third image to the first device.

13. The non-transitory computer-readable storage medium of claim 11, wherein the first input field location comprises coordinates associated with a location of the first input field.

14. The non-transitory computer-readable storage medium of claim 11, further comprising the step of executing an application command associated with the first input field based on the first input event.

15. The non-transitory computer-readable storage medium of claim 11, wherein determining the first input field information comprises:
comparing the plurality of input fields to a plurality of known input field types; and
determining that the first input field matches an input field type included in the plurality of known input field types.

16. The non-transitory computer-readable storage medium of claim 11, wherein determining the first input field information comprises performing the steps of:
analyzing the first image to identify the first input field;
comparing a portion of the first image associated with the first input field to a plurality of known input field types; and
determining that the portion of the first image associated with the first input field matches an input field type included in the plurality of known input field types.

17. The non-transitory computer-readable storage medium of claim 11, wherein the first device comprises a touchscreen device.

18. A computing device, comprising:
a memory; and
a central processing unit coupled to the memory, configured to:
generate a first image of a graphical user interface having a plurality of input fields;
determine first input field information associated with a first input field included in the plurality of input fields, wherein the first input field information comprises a first input field type and a first input field location;
transmit the first image and the first input field information to a first device;
receive a first input event associated with the first input field from the first device;
generate a second image of the graphical user interface based on the first input event; and
transmitting the second image to the first device.

19. The computing device of claim 18, further configured to:
determine second input field information associated with a second input field included in the plurality of input fields, wherein the second input field information comprises a second input field type and a second input field location;
transmit the second input field information with the first image and the first input field information to the first device;
receive a second input event associated with the second input field from the first device;
generate a third image of the graphical user interface based on the second input event; and
transmit the third image to the first device.

20. The computing device of claim 18, wherein the first input field location comprises coordinates associated with a location of the first input field.
